(19) United States
(12) Patent Application Publication
(10) Pub. No.: US 2014/0174995 A1
(43) Pub. Date: Jun. 26, 2014

(54) PAPER SHEET PROCESSING SYSTEM AND PAPER SHEET PROCESSING METHOD

(71) Applicant: Leykim Ang, Yokohama-shi (JP)

(72) Inventor: Leykim Ang, Yokohama-shi (JP)

(21) Appl. No.: 14/136,745

(22) Filed: Dec. 20, 2013

(30) Foreign Application Priority Data
Dec. 20, 2012 (JP) 2012-278276

(51) Int. Cl. B07C 5/342

(52) U.S. Cl. CPC B07C 5/342
USPC 209/546

(57) ABSTRACT

According to one embodiment, a paper sheet processing system includes a reader unit, a determination unit, a sorting controller, a plurality of storage units, and a display. The reader unit is configured to read paper sheet information. The determination unit is configured to determine a storage destination of the paper sheet based on the paper sheet information read. The sorting controller is configured to control sorting of the paper sheet based on a determination result of the storage destination from the determination unit. The plurality of storage units are configured to store the paper sheets sorted through the sorting control of the sorting controller. The display is configured to display the paper sheet information for each storage destination based on the determination result.

### CROSS-REFERENCE TO RELATED APPLICATIONS

This application is based upon and claims the benefit of priority from Japanese Patent Application No. 2012-278276, filed Dec. 20, 2012; the entire contents of which are incorporated herein by reference.

### FIELD

Embodiments described herein relate generally to a paper sheet processing system and a paper sheet processing method.

### BACKGROUND

There is known a paper sheet processing system (banknote processing apparatus) in which a plurality of paper sheets (notes such as paper money) of a plurality of types are aligned and loaded, the paper sheets are sorted depending on a note type or conditions such as defectiveness or an orientation, and each of the sorted paper sheets is stacked in a plurality of stack trays.

For example, a paper money processing apparatus as the paper sheet processing system is an apparatus capable of sorting a plurality of types of paper money depending on a note type or conditions such as a paper money defect state. Such a paper money processing apparatus has a plurality of stack trays allocated depending on a condition of the paper money (such as a type or a paper money defect state). In the paper money processing apparatus, a determination unit determines a type of the paper money or a paper money defect state and counts the number of sheets. Based on the determination result, each note is stacked in each stack tray.

In addition, the determination unit recognizes a serial number (identification information) of the paper money from image data obtained by reading an image of the paper money and outputs the serial number recognition result.

When a jam occurs in the paper sheet processing system, a paper sheet subjected to the counting and a paper sheet not subjected to the counting may exist. Count values confirmed for each stacking unit are displayed on a screen of the paper sheet processing system. An operator checks whether or not there is a paper sheet stacked without being subjected to the counting due to occurrence of a jam. For example, an operator manually counts the number of the stacked paper sheets. As a result, if the number of the stacked paper sheets manually counted does not match the count value displayed on the screen, the paper sheet stacked without being subjected to the counting is extracted, and the extracted paper sheet is re-supplied to the paper sheet processing system. Such a work for distinguishing the paper sheet not subjected to the counting increases a work burden of an operator. In particular, when the number of the stacked paper sheets is excessive, a work for manually counting the number of paper sheets significantly increases a work load of an operator. As a result, a throughput of the paper sheet processing system may be degraded.

A general architecture that implements the various features of the embodiments will now be described with reference to the drawings. The drawings and the associated descriptions are provided to illustrate the embodiments and not to limit the scope of the invention.

### BRIEF DESCRIPTION OF THE DRAWINGS

FIG. 1 is a cross-sectional view schematically illustrating an example of the entire configuration of a paper sheet processing system according to an embodiment of the invention;

FIG. 2 is a detailed cross-sectional view illustrating an example of the entire configuration of a paper sheet processing system according to an embodiment of the invention;

FIG. 3 is an enlarged cross-sectional view illustrating examples of a supply determination unit, a loading unit, and a stacking unit of a paper sheet processing system according to an embodiment of the invention;

FIG. 4 is a block diagram illustrating an exemplary control system of a paper sheet processing system according to an embodiment of the invention;

FIG. 5 is a flowchart illustrating an exemplary process of displaying a serial number of a paper sheet using a paper sheet processing system according to an embodiment of the invention; and

FIG. 6 is a diagram illustrating an exemplary result of processing a paper sheet using a paper sheet processing system according to an embodiment of the invention.

### DETAILED DESCRIPTION

Various embodiments will be described hereinafter with reference to the accompanying drawings.

In general, according to one embodiment, a paper sheet processing system includes a reader unit, a determination unit, a sorting controller, a plurality of storage units, and a display. The reader unit is configured to read paper sheet information from a conveyed paper sheet. The determination unit is configured to determine a storage destination of the paper sheet based on the paper sheet information read from the paper sheet using the reader unit. The sorting controller is configured to control sorting of the paper sheet based on a determination result of the storage destination from the determination unit. The plurality of storage units are configured to store the paper sheets sorted through the sorting control of the sorting controller. The display is configured to display the paper sheet information for each storage destination based on the determination result.

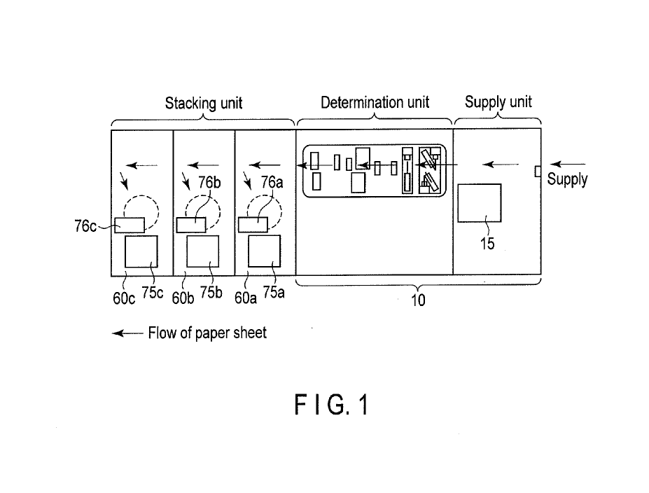

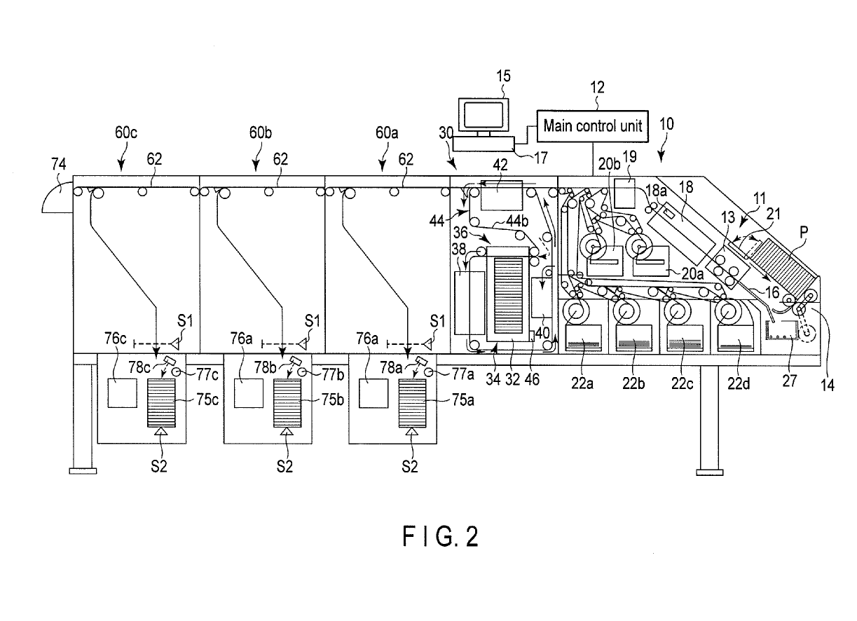

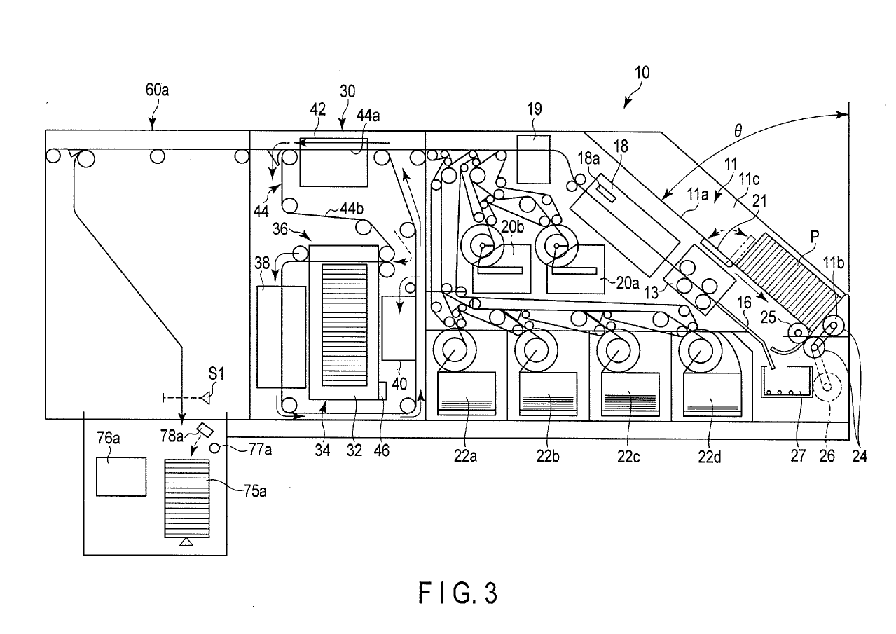

FIG. 1 is a cross-sectional view schematically illustrating an example of the entire configuration of the paper sheet processing system according to an embodiment of the invention. FIG. 2 is a detailed cross-sectional view illustrating an example of the entire configuration of the paper sheet processing system according to an embodiment of the invention. FIG. 3 is an enlarged cross-sectional view illustrating examples of a supply determination unit 10, a loading unit, and a stacking unit of an exemplary paper sheet processing system according to an embodiment of the invention.

As illustrated in FIG. 1, the paper sheet processing system for processing the paper sheets includes a supply determination unit 10 (paper sheet processing unit), three stacking units 60a, 60b, and 60c (a plurality of paper sheet storage units). These modules are arranged side by side in a line in this order and are electrically and mechanically connected to each other. The supply determination unit 10 is provided with a main control unit 12 configured to control operations of the entire system and the main module.

As illustrated in FIG. 2, the paper sheet processing system may have a loading unit 30. Hereinafter, a description will be made for the paper sheet processing system having the loading unit 30.

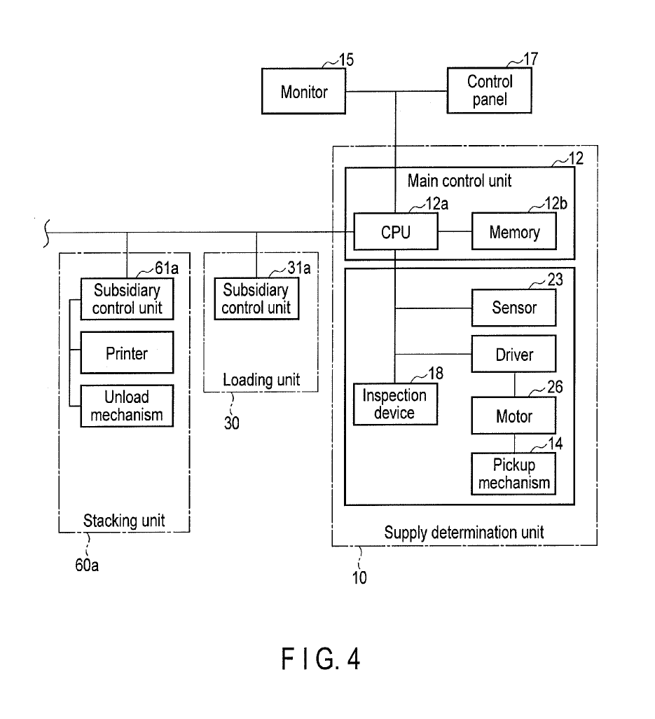

As illustrated in FIGS. 2 and 4, the main control unit 12 is provided in a control board inside the supply determination unit 10. The main control unit 12 includes a CPU 12a configured to control operations of each module and computes efficiency of an operation state and a memory 12b configured to store various data such as a control program, management information, and the like. Various data stored in the memory 12b may include operator IDs, date/time, serial numbers, allocation information, printable information that can be printed on a note-binding band, such as a bank logo, a manager's signature image, fonts of various languages, a processing rate of a plurality of bundles of paper sheets, and the like.

A control panel 17 for inputting various types of information to the system and a monitor 15 as a display unit for displaying input information, an operation state of the system, and a processing state, and the like are connected to the main control unit 12. Each of the loading unit 30 and the three stacking units 60a, 60b, and 60c has a subsidiary control unit 31a or 61a configured to control operations of each module. The subsidiary control unit is connected to the main control unit 12 of the supply determination unit 10 through an interface or a cable (not illustrated) via a local area network (LAN). The main control unit 12 is connected to a host computer (not illustrated) and transmits/receives or processes information to/from the host computer.

Based on manipulation of an operator from the control panel 17 connected to the main control unit 12, various operations of the processing system are set, including setting of a transaction method such as a money input task or an accounting task, a loading process into a loading tray, inspection of the paper sheets in the loading tray, setting of the stack tray for storing the processed paper sheets P, setting of a binding process, setting of an intactness level as a paper sheet determination level, and the like

The main control unit 12 computes management information such as processing efficiency per unit time, processing efficiency for each day, processing efficiency for each operator ID, a total number of processed sheets, a total operation time based on the processing information from an inspection device 18 described below. The management information is stored in the memory 12b and is displayed on the monitor 15.

As illustrated in FIGS. 2 and 3, the supply determination unit 10 includes a sheet supplier 11 where a plurality of paper sheets P are placed in a stacked state; a pickup mechanism 14 for feeding the paper sheets P one by one from the sheet supplier 11; and a conveyance path 16 for conveying the paper sheet P fed by the pickup mechanism 14. The conveyance path 16 is provided with a plurality of endless type conveyance belt sets (not illustrated) extending along the conveyance path. The fed paper sheet P is nipped and conveyed along the conveyance belt.

As illustrated in FIG. 3, the sheet supplier 11 has a support plane 11a extending with an inclination angle θ with respect to a vertical direction, a deck plane 11b extending in a direction substantially perpendicular to the support plane 11a from the lower end of the support plane 11a, and a pair of guide walls 11c erected along both side edges of the support plane 11a and the deck plane 11b. A feeding port lie for feeding the paper sheet P to the inside of the system is formed in a boundary between the support plane 11a and the deck plane 11b. The sheet supplier 11 is provided in one end side of a main body of the supply determination unit 10, and a lower portion of the sheet supplier 11, that is, the deck plane 11b is positioned in the vicinity of the lower end of the main body.

In the sheet supplier 11, a plurality of paper sheets, for example, 2000 or more paper sheets P can be placed in a stacked state. The stacked paper sheets P is mounted on the sheet supplier 11 with an inclination along the support plane while the lowermost paper sheet is placed on the deck plane lib, and a lateral edge in a longitudinal side of the paper sheet is placed on the support plane 11a. The stacked paper sheets P are sequentially fed to the inside of the system through the feeding port lie starting from the lowermost paper sheet P using the pickup mechanism 14.

The inclination angle θ of the support plane 11a is set to a range between 25° and 75°, and preferably, between 30° and 40°. It is noted that the support plane 11a may be rotatable with respect to the main body, and the inclination angle θ may be adjustable.

As illustrated in FIG. 3, the sheet supplier 11 has a backup plate 21 configured to pick up the stacked paper sheet P and move it to the side, that is, to the deck plane 11b. The backup plate 21 is provided such that it can be housed in the support plane 11a and move along the support plane 11a. The backup plate 21 is pivotally supported by the support plane 11a. When, for example, 2,000 paper sheets P are typically placed on the sheet supplier 11, the backup plate 21 is pivoted to a position coplanar with the support plane 11a and is held in that position using a torsion spring and the like. As the paper sheets P are fed, and the number of sheets is reduced, for example, to 800 paper sheets, the backup plate 21 is pivoted to a position erected perpendicularly to the support plane 11a and then abuts on the top of the stacked paper sheets P, so that is moves to the feeding side together with the stacked paper sheets P. As a result, using the backup plate 21, it is possible to move the stacked paper sheets P to the feeding side, prevent the paper sheets from falling down even when the number of paper sheets P is reduced, and stably move the paper sheet P to the feeding position.

As illustrated in FIG. 3, the pickup mechanism 14 configured to feed the paper sheets P one by one from the sheet supplier 11 includes a plurality of pickup rollers (feeding roller) 24 provided to make contact with the paper sheet P on the deck plane 11b, a separation roller 25 provided to make rolling contact with the pickup roller 24 in the feeding port 11e side, and a driving motor 26 configured to rotate the pickup roller 24 at a predetermined speed.

As the pickup roller 24 is rotated, the lowermost paper sheet P is picked up by the pickup roller 24 and is sent to the conveyance path 16 from the feeding port 11e. In this case, the separation roller 25 separates the picked paper sheet from the second or subsequent paper sheet P. As a result, the paper sheets P are sequentially fed from the sheet supplier 11 to the conveyance path 16.

The main control unit 12 adjusts the feeding amount and the feeding rate of the paper sheets for the pickup mechanism 14 depending on the amount of the stacked paper sheets P or an input instruction from an operator. Specifically, the main control unit 12 adjusts a rotation speed of the pickup roller 24 using the driving motor 26 to set the feeding amount, for example, to 1000, 800, or 600 sheets per minute. In addition, the main control unit 12 adjusts the feeding amount of the paper sheets P based on an inspection state of an inspection device 18 described below. For example, when it is difficult to appropriately perform the inspection of the paper sheets P using the inspection device 18, the main control unit 12 reduces the feeding amount from 1000 sheets per minute to 800 sheets per minute. In addition, when the inspection device 18 detects an overlap or a short pitch of the paper sheets P, the main control unit 12 temporarily stops or reverses the pickup roller 24 to prevent the paper sheet P from overlapping and uniformize the feeding pitch of the paper sheet P.

As illustrated in FIGS. 2 and 3, a conveyance pitch correction unit 13 configured to correct a conveyance pitch of the paper sheet P conveyed along the conveyance path 16 and an inspection device 18 configured to inspect every single paper sheet P subjected to the correction of the conveyance pitch are arranged along the conveyance path 16. The inspection device 18 overlies the feeding port 11e of the sheet supplier 11 in a vertical direction. The inspection device 18 detects a note type, a shape, a thickness, a front/rear side, genuineness, defectiveness, an overlap, and the like of the fed paper sheet P. Here, the defectiveness detection means detection of a defective note that is not allowed to re-circulate in the market due to a contamination, a defect, or the like and an intact note allowed to re-circulate in the market. In addition, the inspection device 18 has a camera 18a as a reader unit to read paper sheet information (image of the paper sheet) from the conveyed paper sheet P. The inspection device 18 recognizes paper sheet identification information (serial number) contained in the paper sheet information.

The conveyance path 16 first downwardly extends from the pickup mechanism 14 and the feeding port 11e and then upwardly extends to the inspection device 18 with an inclination with respect to a vertical direction. According to this embodiment, the conveyance path 16 extends substantially along the support plane 11a of the sheet supplier 11, that is, with an inclination in parallel with the support plane 11a. It is noted that the conveyance path 16 may upwardly extend immediately from the feeding port without downwardly extending from the feeding port 11e. In addition, the inspection device 18 may also be inclined along the conveyance path 16.

In this manner, since the conveyance path 16 upwardly extends with an inclination, a foreign object such as a clip, a coin, and a pin fed to the conveyance path 16 together with the paper sheet P from the sheet supplier 11 drops to a lowermost part of the conveyance path along the conveyance path 16 by virtue of gravity. As a result, a foreign object is removed before it enters the inspection device 18. Therefore, it is possible to prevent a damage to the inspection device 18 caused by a foreign object in advance.

Referring to FIG. 3, in the lowermost part of the conveyance path 16, a discharge hole 26a is formed in a guide plate 26 that defines the conveyance path 16, and a foreign object recovery portion is provided under the discharge hole 26a. The foreign object recovery portion includes, for example, a recovery box 27 removable from the main body. A foreign object dropping along the conveyance path 16 is discharged from the discharge hole 26a and is recovered in the recovery box 27.

Referring to FIGS. 2 and 3, the supply determination unit 10 is provided with a pair of rejection units 20a and 20b along the conveyance path 16 and a plurality of stack trays 22a, 22b, 22c, and 22d arranged side by side each of which stacks the paper sheets. The paper sheets P passing through the inspection device 18 are sorted into rejected notes and processing notes using a gate (not illustrated). The rejected note includes a note determined as a counterfeit note by the inspection device 18 or a note determined as an unidentifiable note due to a fold, damage, a skew, an overlap, and the like. The skew means a state that the paper sheet P is sloped with respect to a direction perpendicular to the conveyance direction. The rejected notes are sorted and stacked in the rejection unit 20a or 20b. The rejected notes stacked in the rejection unit 20a or 20b may be set in the sheet supplier 11 by removing the counterfeit note and fed again by correcting an error or may be added to the count data by manually counting them. An inspection result such as a sum of money or the number of notes inspected by the inspection device 18 is sent to and stored in the main control unit 12 and is displayed on the monitor 15.

The processing notes include an intact note as a genuine note or a defective note as a genuine note identified by the inspection device 18. The processing notes are sent to and stacked in the stack trays 22a to 22d. For example, the processing notes are sorted and stacked in any one of the stack trays 22a to 22d depending on the note type, and the defective notes are collectively stacked in a single stack tray.

The conveyance path 16 is connected to the loading unit 30 described below. When the paper sheet is loaded on the loading tray using the loading unit 30, a part or all of the processing notes inspected by the inspection device 18 of the supply determination unit 10 are sent to the loading unit 30 along the conveyance path 16.

The supply determination unit 10 includes a driving mechanism (not illustrated) for driving the pickup mechanism 14, the inspection device 18, the conveyance mechanism, and the like, a power supply, and various other sensors.

Referring to FIGS. 2 and 3, the loading unit 30 includes: a mount portion where an automatic teller machine (ATM) cassette removed from an ATM or a loading tray 32 such as a loading cassette is detachably mounted; a load/unload mechanism 36 that loads paper sheets on the loading tray 32 and unloads paper sheets from the loading tray 32; an inspection device 38; a rejection tray 40; an alignment mechanism 42; and a conveyance path 44 that conveys paper sheets via these components. The conveyance path 44 is provided with a plurality of endless conveyance belt sets along the conveyance path. The paper sheet is nipped and conveyed along the conveyance belt. The conveyance path 44 includes a first conveyance path 44a extending from the conveyance path 16 of the supply determination unit 10 to the stacking unit 60a and a second conveyance path 44b starting from the first conveyance path, passing through the vicinities of the mount portion 34, the inspection device 38, and the rejection tray 40, and returning to the first conveyance path.

The loading tray 32 mounted on the mount portion 34 may include a loading tray only capable of loading (depositing) the paper sheet, a loading tray only capable of unloading (payment) the paper sheet, and a loading tray capable of loading and unloading (depositing and payment) paper sheets.

Here, the loading tray 32 is configured to load a plurality of paper sheets and unload paper sheets from the loading tray 32. In addition, the loading tray 32 has a sensor that detects loading or unloading of a paper sheet and a memory that stores information such as a note type of the loaded paper sheet, the amount of money (the amount in stock), an operator identification, an identification of the loading tray 32 (such as a branch identification or an index indicating the loading tray), and a part number.

The load/unload mechanism 36 of the loading unit 30 includes a pickup roller that unloads paper sheets one by one from the loading tray 32, a loading roller that loads paper sheets on the loading tray 32, a conveyance belt, and the like.

The inspection device 38 detects a note type, a shape, a thickness, a front/rear side, counterfeit, defectiveness, overlapping, a registration number of the paper sheet unloaded from the loading tray 32, and the like. Here, defectiveness detection is performed to detect an intact note allowed to re-circulate in the market and a defective note not allowed to re-circulate in the market due to a contamination or a defect. The defective note may include a paper sheet glued with a tape. The counterfeit detection may be performed, for example, using magnetic detection, image detection, or fluorescent detection performed by irradiating fluorescent light and reading reflection light. In addition, the inspection device 38 counts the unloaded paper sheets to compute the number of sheets and the amount in stock. The inspection result such as the amount in stock or the number of sheets detected by the inspection device 18 is sent to and stored in the main control unit 12 and is displayed on the monitor 15.

The rejection tray 40 is provided in the downstream side of the inspection device 38 with respect to the conveyance direction of the paper sheet. The paper sheets P passing through the inspection device 38 are sorted into a rejected note and a processing note through a gate (not illustrated). The rejected note includes a note determined as a counterfeit note by the inspection device 38 or a note determined as unidentifiable due to a fold, damage, a skew, an overlap, and the like. The rejected note is sent to and stored in the rejection tray 40. In addition, at least one of the stack trays 22a to 22d of the supply determination unit 10 may be set in advance as the rejection tray under control of the main control unit 12, and the rejected note discharged from the loading unit 30 may be sent to and stacked in the rejection tray of the supply determination unit 10. In addition, out of the rejected notes passing through the inspection device 38, the rejected note identified as a counterfeit note and other rejected notes may be stacked in different rejection trays.

The processing note includes an intact note identified as a genuine note or a defective note identified as a genuine note out of the paper sheets P inspected by the inspection device 38. The intact note is returned to the loading tray 32 via the conveyance path 44b and the alignment mechanism 42 and is loaded on the loading tray 32. Under control of the main control unit 12, at least one of the stack trays 22a to 22d of the supply determination unit 10 is set as the defective note tray in advance. The defective note discharged from the loading unit 30 is sent to and stacked in the defective note tray of the supply determination unit 10.

The intact note unloaded from the loading tray 32 may be stacked in the stack trays 22a to 22d of the supply determination unit 10 by any number of sheets defined for each note type in advance. In addition, when the number of sheets stacked in the loading tray 32 is set to, for example, 2,000, a shortage may be recognized based on the number of the intact notes detected by the inspection device 38 as described above. The paper sheets corresponding to the shortage are supplied from the supply determination unit 10 to the loading unit 30 and are loaded on the loading tray 32 via the alignment mechanism 42 and the conveyance path 44. Since the loading tray 32 is mounted on the mount portion 34 of the loading unit 30, the amount in stock of the paper sheets inside the loading tray 32 is automatically informed to the main control unit 12. Therefore, when it is determined that the amount in stock is short of a desired amount, the paper sheets corresponding to the shortage amount may be automatically supplied and loaded from the supply determination unit 10 to the loading tray 32.

Referring to FIGS. 2 and 3, the stacking unit 60a includes a conveyance path 62 communicating with the conveyance path 44a of the loading unit 30, a stacker 75a where the paper sheets conveyed via the conveyance path 62 are stacked, a sensor S1 that detects the paper sheet discharged from the stacker 75a, a display device 76a that displays information about the paper sheets stacked in the stacker 75a, and an indicator 77a that indicates that the paper sheet is appropriately stacked in the stacker 75a.

Referring to FIG. 2, other stacking units 60b and 60c are configured similarly to the stacking unit 60a. The conveyance paths 62 of the stacking units 60a, 60b, and 60c extend while they communicate with each other. In addition, the paper sheet P from the supply determination unit 10 or the loading unit 30 is sent to and stacked in any one of the stacking units 60a, 60b, and 60c.

A safety pocket 74 is provided in the lowermost side of each module. When there is a paper sheet unprocessed in the course of conveyance via each module, this paper sheet is discharged to the safety pocket 74 and is removed from the system.

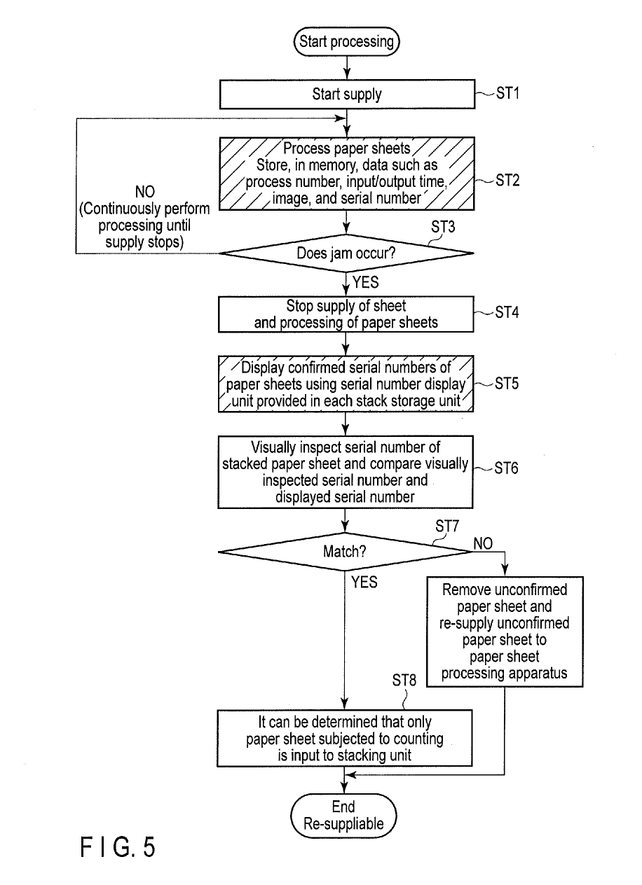

Hereinafter, a process of displaying the serial number of the paper sheet using the paper sheet processing system will be described with reference to the flowchart of FIG. 5.

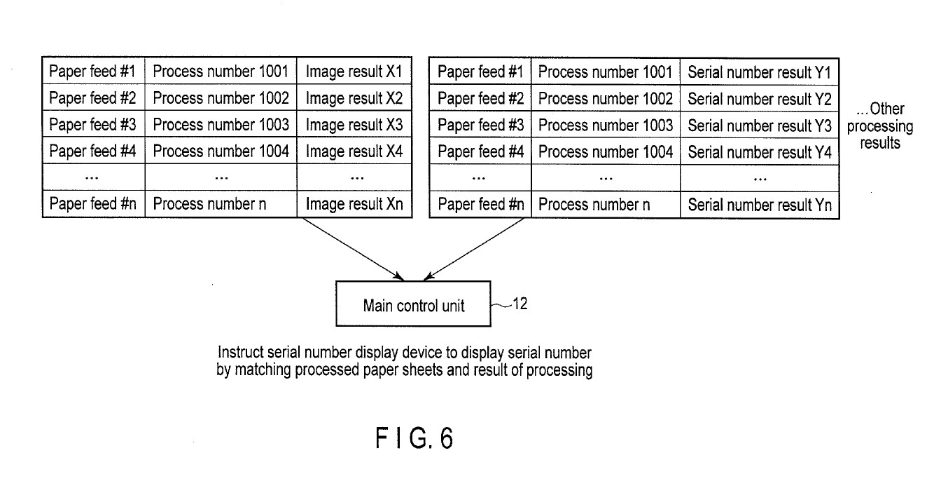

The paper sheet processing system starts supply of the paper sheet (step ST1) and processes the paper sheet (step ST2). For example, the inspection device 18 processes the paper sheet and stores the processing result in the memory together with a process number (refer to FIG. 6). For example, the inspection device 18 detects a note type, a shape, a thickness, a front/rear side, genuineness, defectiveness, an overlap, and the like of the paper sheet. In addition, the inspection device 18 reads paper sheet information (image of the paper sheet) from the paper sheet, recognizes paper sheet identification information (serial number) contained in the paper sheet information, and stores, in the memory, a paper sheet detection result, a paper sheet input/output time, paper sheet information (image of the paper sheet), and paper sheet identification information (serial number) together with the process number. The CPU 12a determines a stacking destination of the paper sheet (storage destination) and controls the paper sheet based on the processing result (such as paper sheet information). The paper sheet is conveyed and sorted. The sorted paper sheet is stacked (stored) in the stacking unit 60a (stacker 75a), the stacking unit 60b (stacker 75b), or the stacking unit 60c (stacker 75c). In addition, the CPU 12a performs control such that the paper sheet information (such as the serial number recognized from the paper sheet information) is displayed for each stacking destination based on the determination result of the stacking destination (storage destination) of the paper sheet.

As described above, a jam may occur while the paper sheet is conveyed (YES in step ST3). As a notification of a jam is received, the CPU 12a stops conveyance (feeding) of the paper sheet and the processing of the paper sheet (step ST4). For example, occurrence of a jam is displayed on the monitor 15.

Through the display control of the CPU 12a described above, the display devices 76a, 76b, and 76c display the paper sheet information (such as the serial number recognized from the paper sheet information) (step ST5). For example, when the first paper sheet of a process number 1001 is sorted to the stacking unit 60a (stacker 75a), the CPU 12a transmits first paper sheet information (such as a serial number recognized from the first paper sheet information) corresponding to the first paper sheet to the stacking unit 60a, and the display device 76a of the stacking unit 60a displays the first paper sheet information (such as a serial number recognized from the first paper sheet information). That is, as the processing is confirmed, and the display device 76a of the stacking unit 60a displays the first paper sheet information (such as a serial number recognized from the first paper sheet information) corresponding to the first paper sheet stacked in the stacker 75a of the stacking unit 60a.

When the second paper sheet of the process number 1002 conveyed after the first paper sheet of the process number 1001 is sorted to the stacking unit 60a, the CPU 12a transmits second paper sheet information (such as a serial number recognized from the second paper sheet information) corresponding to the second paper sheet to the stacking unit 60a, and the display device 76a of the stacking unit 60a displays the second paper sheet information (such as a serial number recognized from the second paper sheet information). That is, as the processing is confirmed, the display device 76a of the stacking unit 60a displays the second paper sheet information (such as a serial number recognized from the second paper sheet information) corresponding to the second paper sheet stacked in the stacker 75a of the stacking unit 60a.

For example, the display device 76a displays the first paper sheet information (such as a serial number recognized from the first paper sheet information) corresponding to the first paper sheet. Subsequently, instead of the first paper sheet information, the display device 76a displays the second paper sheet information (such as a serial number recognized from the second paper sheet information) corresponding to the second paper sheet. That is, the display device 76a updates the display information depending on the stacking of the paper sheet.

Alternatively, the display device 76a displays the second paper sheet information (such as a serial number recognized from the second paper sheet information) corresponding to the second paper sheet while displaying the first paper sheet information (such as a serial number recognized from the first paper sheet) corresponding to the first paper sheet. For example, the display device 76a displays the paper sheet information read from N successively sorted paper sheets (where, N denotes an integer equal to or greater than 2), including the finally sorted paper sheet (the paper sheet processed finally). For example, the display device 76a displays paper sheet information read from 10 successively sorted paper sheets, including the finally sorted paper sheet.

When the first paper sheet of the process number 1001 is sorted to the stacking unit 60b, and the second paper sheet of the process number 1002 is sorted to the stacking unit 60b, the CPU 12a transmits the first paper sheet information (such as a serial number recognized from the first paper sheet information) corresponding to the first paper sheet to the stacking unit 60b and transmits the first paper sheet information (such as a serial number recognized from the first paper sheet information) corresponding to the first paper sheet to the stacking unit 60b. In addition, the display device 76b of the stacking unit 60b displays the first paper sheet information (such as a serial number recognized from the first paper sheet information) and the second paper sheet information (such as a serial number recognized from the second paper sheet information).

In the aforementioned description, the display devices 76a, 76b, and 76c display the paper sheet information (such as a serial number recognized from the paper sheet information) based on the display control of the CPU 12a. However, instead of the display devices 76a, 76b, and 76c, the monitor 15 of the supply determination unit 10 may display the paper sheet information (such as a serial number recognized from the paper sheet information) for each stacking destination through the display control of the CPU 12a.

For example, the monitor 15 may display the first paper sheet information (such as a serial number recognized from the first paper sheet information) by matching the stacking unit 60a or display the second paper sheet information (such as a serial number recognized from the second paper sheet information) by matching the stacking unit 60a.

Alternatively, both the display devices 76a, 76b, and 76c and the monitor 15 may display the paper sheet information (such as a serial number recognized from the paper sheet information).

As occurrence of a jam is recognized, an operator visually identifies the serial numbers of the paper sheets stacked in each stacking unit 60a, 60b, and 60c and the serial numbers displayed on the display devices 76a, 76b, and 76c and determines whether or not the serial numbers of the stacked paper sheets match the serial numbers displayed on the display devices 76a, 76b, and 76c (step ST6). Alternatively, an operator visually identifies the serial numbers of the paper sheets stacked in each stacking unit 60a, 60b, and 60c and the serial numbers displayed on the monitor 15 for each stacking destination and determines whether or not the serial numbers of the stacked paper sheets match the serial numbers displayed for each stacking destination (step ST6).

If they match each other (YES in step ST7), it can be determined that the processed paper sheets (paper sheets subjected to the counting) are stacked in each stacking unit 60a, 60b, and 60c (step ST8), and the unprocessed paper sheets are not stacked in each stacking unit 60a, 60b, and 60c. Then, the processing is terminated.

Otherwise, if they do not match each other (NO in step ST7), it can be determined that any unprocessed paper sheet (paper sheet not subjected to the counting) is stacked in the stacking unit 60a, 60b, or 60c. In this case, the unprocessed paper sheet (paper sheet not subjected to the counting) is extracted from the each stacking unit 60a, 60b, or 60c and is re-supplied (step ST9).

An operator can determine which of a processed paper sheet or an unprocessed paper sheet is stacked just by comparing the serial number of the actually stacked paper sheet with the displayed serial number. As a result, an operator is not necessary to manually count the number of stacked paper sheets and identify whether or not the manually counted number of paper sheets match the count value. Therefore, it is possible to alleviate a burden of the operator.

Alternatively, the display device 76a, 76b, or 76c or the monitor 15 may automatically display the serial number after determination of the stacking destination (storage destination). Furthermore, the display device 76a, 76b, or 76c or the monitor 15 may display the serial number in response to a request from an operator.

In the aforementioned description, the camera 18a of the inspection device 18 reads the paper sheet information (image of the paper sheet) from the paper sheet, and the paper sheet identification information (serial number) contained in the paper sheet information is displayed. Alternatively, the stacking unit 60a, 60b, and 60c may have cameras 78a, 78b, and 78c, respectively, so that the cameras 78a, 78b, and 78c of the stacking unit 60a, 60b, and 60c may read the paper sheet information (image of the paper sheet) from the paper sheets stacked in the stackers 75a, 75b, and 75c, respectively, and the display devices 76a, 76b, and 76c may display the paper sheet identification information (serial numbers) contained in the paper sheet information read by the cameras 78a, 78b, and 78c of the stacking unit 60a, 60b, and 60c, respectively.

Specifically, the camera 78a of the stacking unit 60a reads the paper sheet information (image of the paper sheet) from the paper sheet stacked in the stacker 75a, and the display device 76a displays the paper sheet identification information (serial number) contained in the paper sheet information read by the camera 78a. Similarly, the camera 78b of the stacking unit 60b reads the paper sheet information (image of the paper sheet) from the paper sheet stacked in the stacker 75b, and the display device 76b displays the paper sheet identification information (serial number) contained in the paper sheet information read by the camera 78b. Similarly, the camera 78c of the stacking unit 60c reads the paper sheet information (image of the paper sheet) from the paper sheet stacked in the stacker 75c, and the display device 76c displays the paper sheet identification information (serial number) contained in the paper sheet information read by the camera 78c.

The camera of the inspection device 18 reads the paper sheet information from the paper sheet in the course of conveyance. However, the cameras 78a, 78b, and 78c read the paper sheet information from the stacked paper sheets (paper sheets in a stationary state) and accordingly have higher reading accuracy.

The CPU 12a compares the paper sheet identification information (serial number) recognized from the paper sheet information (image of the paper sheet) read by the camera 18a of the inspection device 18 and the paper sheet identification information (serial number) recognized from the paper sheet information (image of the paper sheet) read by the camera 78a of the stacking unit 60a. If they match each other, the CPU 12a notifies this fact to a subsidiary control unit 61a. The subsidiary control unit 61a receives this notification and controls the indicator 77a of the stacking unit 60a based on the received notification by turning on the indicator 77a and the like to inform this fact. That is, as the CPU 12a detects the matching in response to occurrence of a jam, the indicator 77a informs this fact. Based on the display state (for example, by turning on a light or a blue light) of the indicator 77a, an operator can recognize that the paper sheet subjected to the counting is reliably stacked in the stacking unit 60a without visually identify the paper sheet identification information (serial number) of the paper sheet stacked in the stacking unit 60a. In addition, when the CPU 12a does not detect the matching in response to occurrence of a jam, the indicator 77a does not inform this fact. An operator can recognize that the paper sheet not subjected to the counting is stacked in the stacking unit 60a based on the display state (for example, by turning off a light or turning on a red light) of the indicator 77a.

Similarly, when the paper sheet subjected to the counting is stacked in the stacking unit 60b, the indicator 77b of the stacking unit 60b informs this fact. When the paper sheet not subjected to the counting is stacked in the stacking unit 60b, the indicator 77b of the stacking unit 60b informs this fact. Similarly, when the paper sheet subjected to the counting is stacked in the stacking unit 60c, the indicator 77c of the stacking unit 60c informs this fact. When the paper sheet not subjected to the counting is stacked in the stacking unit 60c, the indicator 77c of the stacking unit 60c informs this fact.

Based on the paper sheet identification information (serial number) recognized from the paper sheet information (image of the paper sheet) read by the camera 18a of the inspection device 18, the paper sheet identification information (serial number) recognized from the paper sheet information (image of the paper sheet) read by the cameras 78a, 78b, and 78c of the stacking units 60a, 60b, and 60c, the determination result on the stacking destination, and the like, the CPU 12a can detect which of the serial numbers of the paper sheets is stacked in which of the stacking units. The CPU 12a stores, in the memory 12b, paper sheet management information indicating which of serial numbers of the paper sheets is stacked in which of the stacking units.

As an operator inputs a serial number using the control panel 17, the main control unit 12 searches information about the paper sheet corresponding to the input serial number based on the paper sheet management information stored in the memory 12b, and the monitor 15 displays the search result. For example, when the paper sheet corresponding to Serial Number_Y1 is stacked in the stacking unit 60a, the paper sheet management information contains information indicating that the paper sheet of Serial Number_Y1 is stacked in the stacking unit 60a. Therefore, as an operator inputs Serial Number_Y1 using the control panel 17, the monitor 15 displays information indicating that the paper sheet of Serial Number_Y1 is stacked in the stacking unit 60a.

For example, when the paper sheet processing system erroneously conveys the paper sheet during the processing (for example, when a paper sheet to be rejected is conveyed without rejection), the monitor 15 may display and inform the stacking destination of the paper sheet of the serial number input by an operator.

A cutter may be connected to the paper sheet processing system. In this case, it is possible to improve counting reliability of the cut sheets using the cutter. The paper sheet processing system sends the cutting target paper sheet subjected to the counting to the cutter via the cutting security area, and the cutter cuts the received paper sheet. That is, the paper sheet processing system recognizes a count value of the cutting target paper sheets (the number of the paper sheets sent to the cutting security area) as the number of the cut paper sheets. However, the cutting target paper sheet not subjected to the counting may be sent to the cutting security area when a jam occurs.

In this regard, in the upstream side (for example, inspection device 18) of the cutting security area, a first camera (for example, camera 18a) for shooting the paper sheet is installed, and a second camera for shooting the paper sheet stored in the cutting security area is installed. If a serial number of the paper sheet shot by the first camera matches a serial number of the paper sheet shot by the second camera when a jam or the like occurs, it can be detected that the paper sheet subjected to the counting in the inspection device 18 is stored in the cutting security area. Therefore, it can be determined that the number of the cut paper sheets is appropriate. In addition, if a serial number of the paper sheet shot by the first camera does not match a serial number of the paper sheet shot by the second camera when a jam or the like occurs, it can be detected that the paper sheet not subjected to the counting is highly likely stored in the cutting security area. In addition, since it is possible to search the lost paper sheet based on the serial number of the paper sheet, it is possible to find the lost paper sheet through the aforementioned searching when the paper sheet not subjected to the counting (lost paper sheet) is stored in the cutting security area.

This embodiment can be summarized as follows.

(1) In the paper sheet processing system, a display device capable of displaying the serial number is installed in each stacking unit. The display device of each stacking unit displays a serial number of the paper sheet confirmed when a jam occurs. That is, for each stacking unit, the display device of each stacking unit displays a serial number of the paper sheet confirmed when a jam occurs. An operator visually compares the serial number displayed on the serial number display device with the serial numbers of the paper sheets that physically finally enter each stacking unit. If the displayed serial number matches the serial number of the finally stacked paper sheet, it can be determined that only the paper sheets subjected to the counting are stacked. Therefore, it is possible to reduce an effort to count the number of the paper sheets stacked in the stacking unit. Therefore, it is possible to alleviate a burden of an operator and improve a throughput of the paper sheet processing system. It is noted that the monitor 15 of the supply determination unit 10 may display the serial number of the paper sheet for each stacking unit.

(2) The serial number display device installed in each stacking unit displays, for example, the serial numbers of 10 successive paper sheets including the final paper sheet as well as the serial number of the finally confirmed paper sheet. It is noted that the monitor 15 of the supply determination unit 10 may display the serial numbers of 10 successive paper sheets including the final paper sheet for each stacking unit.

(3) The serial number of the paper sheet shot by the camera 18a installed in the supply determination unit 10 side of the paper sheet processing system is compared with the serial numbers of the paper sheets shot by the cameras 78a, 78b, and 78c installed in the stacking units 60a, 60b, and 60c sides of the paper sheet processing system. Based on the comparison result, the indicators 77a, 77b, and 77c, when the paper sheets subjected to the counting are stacked in the stacking units 60a, 60b, and 60c, the indicators 77a, 77b, and 77c of the paper sheet processing system informs this fact. When the paper sheet not subjected to the counting is stacked in the stacking units 60a, 60b, or 60c, this fact is informed. As a result, it is possible to significantly alleviate a work burden of an operator.

(4) In the paper sheet processing system, a paper sheet may be searched based on the input serial number. For example, using this search functionality, an operator can track the paper sheet erroneously conveyed during the processing of the paper sheet processing system.

(5) In the paper sheet processing system, it can be determined whether or not the paper sheet remaining in the cutting security area is subjected to the counting. In addition, the paper sheet remaining in the cutting security area can be searched based on the serial number.

As described above, it is possible to minimize an effort to manually count the paper sheets stored in the stacking unit when a jam occurs. Therefore, it is possible to alleviate a burden of an operator and improve a throughput.

In addition, since the serial numbers of the paper sheets confirmed through the counting are displayed on the serial number display devices of each stacking unit, an operator can visually and physically compare the serial number of the paper sheet stored in the stacking unit with the displayed serial numbers when a jam occurs. Therefore, it is possible to determine the counting confirmation state.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A paper sheet processing system comprising:
a reader unit configured to read paper sheet information from a conveyed paper sheet;
a determination unit configured to determine a storage destination of the paper sheet based on the paper sheet information read from the paper sheet using the reader unit;
a sorting controller configured to control sorting of the paper sheet based on a determination result of the storage destination from the determination unit;
a plurality of storage units configured to store the paper sheets sorted through the sorting control of the sorting controller; and
a display configured to display the paper sheet information for each storage destination based on the determination result.

2. The paper sheet processing system according to claim 1, further comprising a paper sheet processing unit and a plurality of paper sheet storage units,
wherein the paper sheet processing unit includes the reader unit, the determination unit, and the sorting controller,
each of the paper sheet storage units includes the storage unit and the display,
the determination unit is configured to transmit the paper sheet information to the first paper sheet storage unit if a storage destination of the paper sheet is determined as the first paper sheet storage unit based on the paper sheet information,
the sorting controller is configured to sort the paper sheet to the first paper sheet storage unit based on the determination result for the storage destination performed by the determination unit,
the storage unit of the first paper sheet storage unit is configured to store the paper sheet sorted through the sorting control of the sorting controller, and
the display of the first paper sheet storage unit is configured to display the paper sheet information.

3. The paper sheet processing system according to claim 2, wherein the reader unit is configured to read first paper sheet information from a first conveyed paper sheet and read second paper sheet information from a second paper sheet conveyed after the first paper sheet, and
the determination unit is configured to transmit the first paper sheet information to the first paper sheet storage unit if a storage destination of the first paper sheet is determined as the first paper sheet storage unit based on the first paper sheet information, and transmit the second paper sheet information to the first paper sheet storage unit if a storage destination of the second paper sheet is determined as the first paper sheet storage unit based on the second paper sheet information,
the sorting controller is configured to control such that the first paper sheet is sorted to the first paper sheet storage unit, and the second paper sheet is sorted to the first paper sheet storage unit based on the determination result for the storage destination of the determination unit,
the storage unit of the first paper sheet storage unit is configured to store the first paper sheet and the second paper sheet sorted through the sorting control of the sorting controller, and
the display of the first paper sheet storage unit is configured to display the first paper sheet information and display the second paper sheet information.

4. The paper sheet processing system according to claim 3, wherein the display of the first paper sheet storage unit is configured to display the first paper sheet information and then display the second paper sheet information instead of the first paper sheet information.

5. The paper sheet processing system according to claim 3, wherein the display of the first paper sheet storage unit is configured to display paper sheet information read from successively sorted N paper sheets (where N denotes an integer equal to or greater than 2) including a paper sheet finally sorted for the first paper sheet storage unit.

6. The paper sheet processing system according to claim 1, wherein the reader unit is configured to read a paper sheet image from the paper sheet and recognize paper sheet identification information included in the paper sheet image, and
the display is configured to display the paper sheet identification information.

7. A paper sheet processing system comprising:
a first reader unit configured to read paper sheet information from a conveyed paper sheet;
a determination unit configured to determine a storage destination of the paper sheet based on the paper sheet information read from the paper sheet using the first reader unit;
a sorting controller configured to control sorting of the paper sheet based on a determination result of the storage destination from the determination unit;
a plurality of storage units configured to store the paper sheet sorted by a sorting control of the sorting controller;
a second reader unit configured to read paper sheet information from the paper sheet stored in the storage unit; and
a display configured to display the paper sheet information read from the paper sheet using the second reader unit.

8. The paper sheet processing system according to claim 7, further comprising an indication unit configured to indicate a result of comparing paper sheet identification information contained in the paper sheet information read by the first reader unit and paper sheet identification information contained in the paper sheet information read by the second reader unit.

9. The paper sheet processing system according to claim 8, further comprising a paper sheet processing unit and a plurality of paper sheet storage units,
wherein the paper sheet processing unit includes the first reader unit, the determination unit, and the sorting controller,
each of the paper sheet storage units includes the storage unit, the second reader unit, the display, and the indication unit.
the determination unit is configured to transmit the paper sheet information to the first paper sheet storage unit if a storage destination of the paper sheet is determined as the first paper sheet storage unit based on the paper sheet information,
the sorting controller is configured to control sorting of the paper sheet to the first paper sheet storage unit based on the determination result of the storage destination from the determination unit,
the storage unit of the first paper sheet storage unit is configured to store the paper sheet sorted through the sorting control of the sorting controller,
the display of the first paper sheet storage unit is configured to display the paper sheet information read from the paper sheet using the second reader unit, and
the indication unit is configured to indicate a fact that paper sheet identification information contained in the paper sheet information read by the first reader unit matches paper sheet identification information contained in the paper sheet information read by the second reader unit.

10. A paper sheet processing method comprising:
reading paper sheet information from a conveyed paper sheet;
determining a storage destination of the paper sheet based on the paper sheet information read from the paper sheet;
controlling sorting of the paper sheet based on a determination result of the storage destination;
storing the paper sheet sorted through the sorting control; and
displaying the paper sheet information for each storage destination based on the determination result.
